(19) United States
(12) Patent Application Publication
(10) Pub. No.: US 2010/0277267 A1
(43) Pub. Date: Nov. 4, 2010

(54) MAGNETIC COMPONENTS AND METHODS OF MANUFACTURING THE SAME

(76) Inventors: Robert James Bogert, Lake Worth, FL (US); Yipeng Yan, Pudong (CN); Frank Anthony Doljack, Pleasanton, CA (US); Hundi Panduranga Kamath, Los Altos, CA (US)

Correspondence Address: Armstrong Teasdale LLP (16463), 7700 Forsyth Boulevard, Suite 1800, St. Louis, MO, 63105, US

(21) Appl. No.: 12/766,300

(22) Filed: Apr. 23, 2010

Related U.S. Application Data
(60) Provisional application No. 61/175,269, filed on May 4, 2009.

(51) Int. Cl. H01F 17/04; H01F 41/02

(52) U.S. Cl. 336/221; 29/606; 336/233

(57) ABSTRACT

Magnetic component assemblies including layered moldable magnetic materials and coils are advantageously utilized in providing surface mount magnetic components such as inductors and transformers.

### CROSS REFERENCE TO RELATED APPLICATIONS

This application claims the benefit of U.S. Provisional Patent Application No. 61/175,269 filed May 4, 2009, the complete disclosure of which is hereby incorporated by reference in its entirety.

The present application also relates to subject matter disclosed in the following commonly owned and co-pending patent applications: U.S. patent application Ser. No. 12/429,856 filed Apr. 24, 2009 and entitled “Surface Mount Magnetic Component Assembly”; U.S. patent Ser. No. 12/181,436 filed Jul. 29, 2008 and entitled “A Magnetic Electrical Device”, and U.S. patent application Ser. No. 11/519,349 filed June Sep. 12, 2006 and entitled “Low Profile Layered Coil and Cores for Magnetic Components”, the complete disclosures of which are also incorporated by reference in their entirety.

### BACKGROUND OF THE INVENTION

The field of the invention relates generally to magnetic components and their manufacture, and more specifically to magnetic, surface mount electronic components such as inductors and transformers.

With advancements in electronic packaging, the manufacture of smaller, yet more powerful, electronic devices has become possible. To reduce an overall size of such devices, electronic components used to manufacture them have become increasingly miniaturized. Manufacturing electronic components to meet such requirements presents many difficulties, thereby making manufacturing processes more expensive, and undesirably increasing the cost of the electronic components.

Manufacturing processes for magnetic components such as inductors and transformers, like other components, have been scrutinized as a way to reduce costs in the highly competitive electronics manufacturing business. Reduction of manufacturing costs is particularly desirable when the components being manufactured are low cost, high volume components. In high volume, mass production processes for such components, and also electronic devices utilizing the components, any reduction in manufacturing costs is, of course, significant.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is an exploded view of a first exemplary magnetic component assembly formed in accordance with an exemplary embodiment of the invention.

FIG. 2 is a perspective view of a first exemplary coil for the magnetic component assembly shown in FIG. 1.

FIG. 3 is a cross sectional view of the wire of the coil shown in FIG. 2.

FIG. 4 is perspective view of a second exemplary coil for the magnetic component assembly shown in FIG. 1.

FIG. 5 is a cross sectional view of the wire of the coil shown in FIG. 4.

FIG. 6 is a perspective view of a second exemplary magnetic component assembly formed in accordance with an exemplary embodiment of the invention.

FIG. 7 is a perspective view of a third exemplary magnetic component assembly formed in accordance with an exemplary embodiment of the invention.

FIG. 8 is an assembly view of the component shown in FIG. 7.

### DETAILED DESCRIPTION OF THE INVENTION

Exemplary embodiments of inventive electronic component designs are described herein that overcome numerous difficulties in the art. To understand the invention to its fullest extent, the following disclosure is presented in different segments or parts, wherein Part I discusses particular problems and difficulties, and Part II describes exemplary component constructions and assemblies for overcoming such problems.

### I. Introduction to the Invention

Conventional magnetic components such as inductors for circuit board applications typically include a magnetic core and a conductive winding, sometimes referred to as a coil, within the core. The core may be fabricated from discrete core pieces fabricated from magnetic material with the winding placed between the core pieces. Various shapes and types of core pieces and assemblies are familiar to those in the art, including but not necessarily limited to U core and I core assemblies, ER core and I core assemblies, ER core and ER core assemblies, a pot core and T core assemblies, and other matching shapes. The discrete core pieces may be bonded together with an adhesive and typically are physically spaced or gapped from one another.

In some known components, for example, the coils are fabricated from a conductive wire that is wound around the core or a terminal clip. That is, the wire may be wrapped around a core piece, sometimes referred to as a drum core or other bobbin core, after the core pieces has been completely formed. Each free end of the coil may be referred to as a lead and may be used for coupling the inductor to an electrical circuit, either via direct attachment to a circuit board or via an indirect connection through a terminal clip. Especially for small core pieces, winding the coil in a cost effective and reliable manner is challenging. Hand wound components tend to be inconsistent in their performance. The shape of the core pieces renders them quite fragile and prone to core cracking as the coil is wound, and variation in the gaps between the core pieces can produce undesirable variation in component performance. A further difficulty is that the DC resistance (“DCR”) may undesirably vary due to uneven winding and tension during the winding process.

In other known components, the coils of known surface mount magnetic components are typically separately fabricated from the core pieces and later assembled with the core pieces. That is, the coils are sometimes referred to as being pre-formed or pre-wound to avoid issues attributable to hand winding of the coil and to simplify the assembly of the magnetic components. Such pre-formed coils are especially advantageous for small component sizes.

In order to make electrical connection to the coils when the magnetic components are surface mounted on a circuit board, conductive terminals or clips are typically provided. The clips are assembled on the shaped core pieces and are electrically connected to the respective ends of the coil. The terminal clips typically include generally flat and planar regions that may be electrically connected to conductive traces and pads on a circuit board using, for example, known soldering techniques. When so connected and when the circuit board is energized, electrical current may flow from the circuit board to one of the terminal clips, through the coil to the other of the terminal clips, and back to the circuit board. In the case of an inductor, current flow through the coil induces magnetic fields and energy in the magnetic core. More than one coil may be provided.

In the case of a transformer, a primary coil and a secondary coil are provided, wherein current flow through the primary coil induces current flow in the secondary coil. The manufacture of transformer components presents similar challenges as inductor components.

For increasingly miniaturized components, providing physically gapped cores is challenging. Establishing and maintaining consistent gap sizes is difficult to reliably accomplish in a cost effective manner.

A number of practical issues are also presented with regard to making the electrical connection between the coils and the terminal clips in miniaturized, surface mount magnetic components. A rather fragile connection between the coil and terminal clips is typically made external to the core and is consequently vulnerable to separation. In some cases, it is known to wrap the ends of coil around a portion of the clips to ensure a reliable mechanical and electrical connection between the coil and the clips. This has proven tedious, however, from a manufacturing perspective and easier and quicker termination solutions would be desirable. Additionally, wrapping of the coil ends is not practical for certain types of coils, such as coils having rectangular cross section with flat surfaces that are not as flexible as thin, round wire constructions.

As electronic devices continue recent trends of becoming increasingly powerful, magnetic components such as inductors are also required to conduct increasing amounts of current. As a result the wire gauge used to manufacture the coils is typically increased. Because of the increased size of the wire used to fabricate the coil, when round wire is used to fabricate the coil the ends are typically flattened to a suitable thickness and width to satisfactorily make the mechanical and electrical connection to the terminal clips using for example, soldering, welding, or conductive adhesives and the like. The larger the wire gauge, however, the more difficult it is to flatten the ends of the coil to suitably connect them to the terminal clips. Such difficulties have resulted in inconsistent connections between the coil and the terminal clips that can lead to undesirable performance issues and variation for the magnetic components in use. Reducing such variation has proven very difficult and costly.

Fabricating the coils from flat, rather than round conductors may alleviate such issues for certain applications, but flat conductors tend to be more rigid and more difficult to form into the coils in the first instance and thus introduce other manufacturing issues. The use of flat, as opposed to round, conductors can also alter the performance of the component in use, sometimes undesirably. Additionally, in some known constructions, particularly those including coils fabricated from flat conductors, termination features such as hooks or other structural features may be formed into the ends of the coil to facilitate connections to the terminal clips. Forming such features into the ends of the coils, however, can introduce further expenses in the manufacturing process.

Recent trends to reduce the size, yet increase the power and capabilities of electronic devices present still further challenges. As the size of electronic devices are decreased, the size of the electronic components utilized in them must accordingly be reduced, and hence efforts have been directed to economically manufacture power inductors and transformers having relatively small, sometimes miniaturized, structures despite carrying an increased amount of electrical current to power the device. The magnetic core structures are desirably provided with lower and lower profiles relative to circuit boards to allow slim and sometimes very thin profiles of the electrical devices. Meeting such requirement presents still further difficulties. Still other difficulties are presented for components that are connected to multi-phase electrical power systems, wherein accommodating different phases of electrical power in a miniaturized device is difficult.

Efforts to optimize the footprint and the profile of magnetic components are of great interest to component manufacturers looking to meet the dimensional requirements of modern electronic devices. Each component on a circuit board may be generally defined by a perpendicular width and depth dimension measured in a plane parallel to the circuit board, the product of the width and depth determining the surface area occupied by the component on the circuit board, sometimes referred to as the “footprint” of the component. On the other hand, the overall height of the component, measured in a direction that is normal or perpendicular to the circuit board, is sometimes referred to as the “profile” of the component. The footprint of the components in part determines how many components may be installed on a circuit board, and the profile in part determines the spacing allowed between parallel circuit boards in the electronic device. Smaller electronic devices generally require more components to be installed on each circuit board present, a reduced clearance between adjacent circuit boards, or both.

### II. Exemplary Inventive Magnetic Component Assemblies and Methods of Manufacture

Various embodiments of magnetic components are described below including magnetic body constructions and coil constructions that provide manufacturing and assembly advantages over existing magnetic components for circuit board applications. As will be appreciated below, the advantages are provided at least in part because of the magnetic materials utilized which may be molded over the coils, thereby eliminating assembly steps of discrete, gapped cores and coils. Also, the magnetic materials have distributed gap properties that avoids any need to physically gap or separate different pieces of magnetic materials. As such, difficulties and expenses associated with establishing and maintaining consistent physical gap sizes are advantageously avoided. Still other advantages are in part apparent and in part pointed out hereinafter.

Manufacturing steps associated with the devices described are in part apparent and in part specifically described below. Likewise, devices associated with method steps described are in part apparent and in part explicitly described below. That is the devices and methodology of the invention will not necessarily be separately described in the discussion below, but are believed to be well within the purview of those in the art without further explanation.

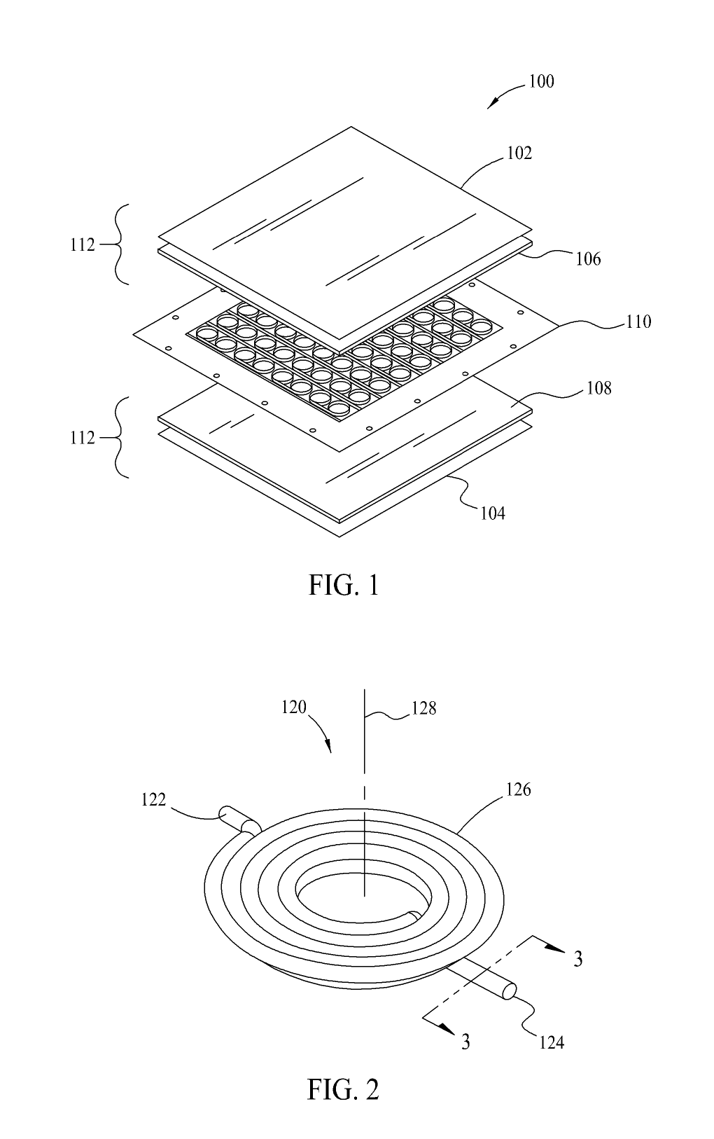

Referring now to FIG. 1, a magnetic component assembly 100 is fabricated in a layered construction wherein multiple layers are stacked and assembled in a batch process.

The assembly 100 as illustrated includes a plurality of layers including outer magnetic layers 102 and 104, inner magnetic layers 106 and 108, and a coil layer 110. The inner magnetic layers 106 and 108 are positioned on opposing sides of the coil layer 110 and sandwich the coil layer 110 in between. The outer magnetic layers 102 and 104 are positioned on surfaces of the inner magnetic layers 106 and 108 opposite the coil layer 110.

In an exemplary embodiment each of the magnetic layers 102, 104, 106 and 108 is fabricated from a moldable magnetic material which may be, for example, a mixture of magnetic powder particles and a polymeric binder having distributed gap properties as those in the art will no doubt appreciate. The magnetic layers 102, 104, 106 and 108 may accordingly be pressed around the coil layer 110, and pressed to one another, to form an integral or monolithic magnetic body 112 above, below and around the coil layer 110. While four magnetic layers and one coil layer are shown, it is contemplated that greater or fewer numbers of magnetic layers and more than one coil layer 110 could be utilized in further and/or alternative embodiments.

In an exemplary embodiment, materials used to fabricate the magnetic layers exhibit a relative magnetic permeability μᵣ of much greater than one to produce sufficient inductance for a miniature power inductor component. More specifically, in an exemplary embodiment the magnetic permeability μᵣ may be at least 10.0 or more.

The coil layer 110, as shown in FIG. 1 includes a plurality of coils, sometimes also referred to as windings. Any number of coils may be utilized in the coil layer 110. The coils in the coil layer 110 may be fabricated from conductive materials in any manner, including but not limited to those described in the related commonly owned patent applications referenced above. For example, the coil layer 110 in different embodiments may each be formed from flat wire conductors wound about an axis for a number of turns, round wire conductors wound about an axis for a number of turns, or by printing techniques and the like on rigid or flexible substrate materials.

Each coil in the coil layer 110 may include any number of turns or loops, including fractional or partial turns less than one complete turn, to achieve a desired magnetic effect, such as an inductance value for a magnetic component. The turns or loops may include a number of straight conductive paths joined at their ends, curved conductive paths, spiral conductive paths, serpentine conductive paths or still other known shapes and configurations. The coils in the coil layer 110 may be formed as generally planar elements, or may alternatively be formed as a three dimensional, free standing coil element. In the latter case where freestanding coil elements are used, the free standing elements may be coupled to a lead frame for manufacturing purposes.

The magnetic powder particles used to form the magnetic layers 102, 104, 106 and 108 may be, in various embodiments, Ferrite particles, Iron (Fe) particles, Sendust (Fe—Si—Al) particles, MPP (Ni—Mo—Fe) particles, HighFlux (Ni—Fe) particles, Megaflux (Fe—Si Alloy) particles, iron-based amorphous powder particles, cobalt-based amorphous powder particles, or other equivalent materials known in the art. When such magnetic powder particles are mixed with a polymeric binder material the resultant magnetic material exhibits distributed gap properties that avoids any need to physically gap or separate different pieces of magnetic materials. As such, difficulties and expenses associated with establishing and maintaining consistent physical gap sizes are advantageously avoided. For high current applications, a pre-annealed magnetic amorphous metal powder combined with a polymer binder is believed to be advantageous.

In different embodiments, the magnetic layers 102, 104, 106 and 108 may be fabricated from the same type of magnetic particles or different types of magnetic particles. That is, in one embodiment, all the magnetic layers 102, 104, 106 and 108 may be fabricated from one and the same type of magnetic particles such that the layers 102, 104, 106 and 108 have substantially similar, if not identical, magnetic properties. In another embodiment, however, one or more of the layers 102, 104, 106 and 108 could be fabricated from a different type of magnetic powder particle than the other layers. For example, the inner magnetic layers 106 and 108 may include a different type of magnetic particles than the outer magnetic layers 102 and 104, such that the inner layers 106 and 108 have different properties from the outer magnetic layers 102 and 104. The performance characteristics of completed components may accordingly be varied depending on the number of magnetic layers utilized and the type of magnetic materials used to form each of the magnetic layers.

Various formulations of the magnetic composite materials used to form the sheets 102, 104, 106 and 108 are possible to achieve varying levels of magnetic performance of the component assembly in use. In general, however, in a power inductor application, the magnetic performance of the material is generally proportional to the flux density saturation point (Bsat) of the magnetic particles used in the layers, the permeability (μ) of the magnetic particles, the loading (% by weight) of the magnetic particles in the layers, and the bulk density of the layers after being pressed around the coil as explained below. That is, by increasing the magnetic saturation point, the permeability, the loading and the bulk density a higher inductance will be realized and performance will be improved.

On the other hand, the magnetic performance of the component assembly is inversely proportional to the amount of binder material used in the layers 102, 104, 106 and 108. Thus, as the loading of the binder material is increased, the inductance value of the end component tends to decrease, as well as the overall magnetic performance of the component. Each of Bsat and μ are material properties associated with the magnetic particles and may vary among different types of particles, while the loading of the magnetic particles and the loading of the binder may be varied among different formulations of the layers.

For inductor components, the considerations above can be utilized to strategically select materials and layer formulations to achieve specific objectives. As one example, metal powder materials may be preferred over ferrite materials for use as the magnetic powder materials in higher power indicator applications because metal powders, such as Fe—Si particles have a higher Bsat value. The Bsat value refers the maximum flux density B in a magnetic material attainable by an application of an external magnetic field intensity H. A magnetization curve, sometimes referred to as a B-H curve wherein a flux density B is plotted against a range of magnetic field intensity H may reveal the Bsat value for any given material. The initial part of the B-H curve defines the permeability or propensity of the material to become magnetized. Bsat refers to the point in the B-H curve where a maximum state of magnetization or flux of the material is established, such that the magnetic flux stays more or less constant even if the magnetic field intensity continues to increase. In other words, the point where the B-H curve reaches and maintains a minimum slope represents the flux density saturation point (Bsat).

Additionally, metal powder particles, such as Fe—Si particles have a relatively high level of permeability, whereas ferrite materials such as FeNi (permalloy) have a relatively low permeability. Generally speaking, a higher permeability slope in the B-H curve of the metal particles used, the greater the ability of the composite material to store magnetic flux and energy at a specified current level, which induces the magnetic field generating the flux.

As FIG. 1 illustrates, the magnetic layers 102, 104, 106 and 108 may be provided in relatively thin sheets that may be stacked with the coil layer 110 and joined to one another in a lamination process or via other techniques known in the art. As used herein, the term “lamination” shall refer to a process wherein the magnetic layers are joined or united as layers, and remain as identifiable layers after being joined and united. Also, the polymeric binder material used to fabricate the magnetic layers may include thermoplastic resins that allow for pressure lamination of the powder sheets without heating during the lamination process. Expenses and costs associated with elevated temperatures of heat lamination, that are required by other known laminate materials, are therefore obviated in favor of pressure lamination. The magnetic sheets may be placed in a mold or other pressure vessel, and compressed to laminate the magnetic powder sheets to one another. The magnetic layers 102, 104, 106 and 108 may be prefabricated at a separate stage of manufacture to simplify the formation of the magnetic component at a later assembly stage.

Additionally, the magnetic material is beneficially moldable into a desired shape through, for example, compression molding techniques or other techniques to couple the layers to the coil and to define the magnetic body into a desired shape. The ability to mold the material is advantageous in that the magnetic body can be formed around the coil layer(s) 110 in an integral or monolithic structure including the coil, and a separate manufacturing step of assembling the coil(s) to a magnetic structure is avoided. Various shapes of magnetic bodies may be provided in various embodiments.

Once the component assembly 100 is secured together, the assembly 100 may be cut, diced, singulated or otherwise separated into discrete, individual components. Each component may be a substantially rectangular, chip type component, although other variations are possible. Each component may include a single coil or multiple coils depending on the desired end use or application. Surface mount termination structure, such as any of the termination structures described in the related applications herein incorporated by reference, may be provided to the assembly 100 before or after the components are singulated. The components may be mounted to a surface of a circuit board using known soldering techniques and the like to establish electrical connections between the circuitry on the boards and the coils in the magnetic components.

The components may be specifically adapted for use as transformers or inductors in direct current (DC) power applications, single phase voltage converter power applications, two phase voltage converter power applications, three phase voltage converter power applications, and multi-phase power applications. In various embodiments, the coils may be electrically connected in series or in parallel, either in the components themselves or via circuitry in the circuit boards on which they are mounted, to accomplish different objectives.

When two or more independent coils are provided in one magnetic component, the coils may be arranged so that there is flux sharing between the coils. That is, the coils utilize common flux paths through portions of a single magnetic body.

While a batch fabrication process is illustrated in FIG. 1, it is understood that individual, discrete magnetic components could be fabricated using other processes if desired. That is, the moldable magnetic material may be pressed around, for example, only the desired number of coils for the individual device. As one example, for multi-phase power applications the moldable magnetic material may be pressed around two or more independent coils, providing an integral body and coil structure that may be completed by adding any necessary termination structure.

FIG. 2 is a perspective view of a first exemplary wire coil 120 that may be utilized in constructing magnetic components such as those described above. As shown in FIG. 2, the wire coil 120 includes opposing ends 122 and 124, sometimes referred to as leads, with a winding portion 126 extending between the ends 120 and 122. The wire conductor used to fabricate the coil 120 may be fabricated from copper or another conductive metal or alloy known in the art.

The wire may be flexibly wound around an axis 128 in a known manner to provide a winding portion 126 having a number of turns to achieve a desired effect, such as, for example, a desired inductance value for a selected end use or application of the component. As those in the art will appreciate, an inductance value of the winding portion 126 depends primarily upon the number of turns of the wire, the specific material of the wire used to fabricate the coil, and the cross sectional area of the wire used to fabricate the coil. As such, inductance ratings of the magnetic component may be varied considerably for different applications by varying the number of coil turns, the arrangement of the turns, and the cross sectional area of the coil turns. Many coils 120 may be prefabricated and connected to a lead frame to form the coil layer 110 (FIG. 1) for manufacturing purposes.

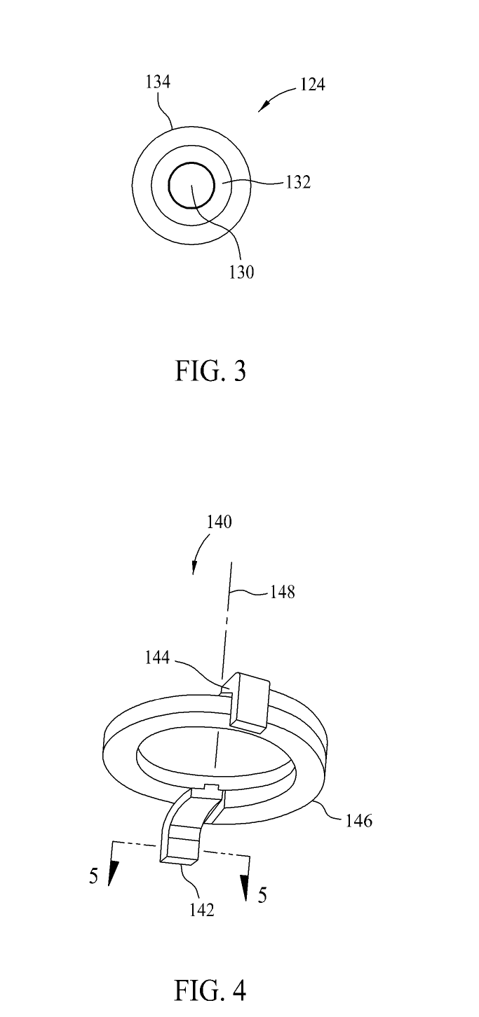

FIG. 3 is a cross sectional view of the coil end 124 illustrating further features of the wire used to fabricate the coil 120 (FIG. 2). While only the coil end 124 is illustrated, it is understood that the entire coil is provided with similar features. In other embodiments, the features shown in FIG. 3 could be provided in some, but not all portions of the coil. As one example, the features shown in FIG. 3 could be provided in the winding portion 126 (FIG. 2) but not the ends 122, 124. Other variations are likewise possible.

The wire conductor 130 is seen in the center of the cross section. In the example shown in FIG. 3, the wire conductor 130 is generally circular in cross section, and hence the wire conductor is sometimes referred to as a round wire. An insulation 132 may be provided over the wire conductor 130 to avoid electrical shorting of the wire with adjacent magnetic powder particles in the completed assembly, as well as to provide some protection to the coil during manufacturing processes. Any insulating material sufficient for such purposes may be provided in any known manner, including but not limited to coating techniques or dipping techniques.

As also shown in FIG. 3, a bonding agent 134 is also provided. The bonding agent may optionally be heat activated or chemically activated during manufacture of the component assembly. The bonding agent beneficially provides additional structural strength and integrity and improved bonding between the coil and the magnetic body. Bonding agents suitable for such purposes may be provided in any known manner, including but not limited to coating techniques or dipping techniques.

While the insulation 132 and bonding agent 134 are advantageous, it is contemplated that they may be considered optional, individually and collectively, in different embodiments. That is, the insulation 132 and/or the bonding agent 134 need not be present in all embodiments.

FIG. 4 is a perspective view of a second exemplary wire coil 140 that may be used in the magnetic component assembly 100 (FIG. 1) in lieu of the coil 120 (FIG. 2). As shown in FIG. 4, the wire coil 140 includes opposing ends 142 and 144, sometimes referred to as leads, with a winding portion 146 extending between the ends 142 and 144. The wire conductor used to fabricate the coil 140 may be fabricated from copper or another conductive metal or alloy known in the art.

The wire may be flexibly formed or wound around an axis 148 in a known manner to provide a winding portion 146 having a number of turns to achieve a desired effect, such as, for example, a desired inductance value for a selected end use application of the component.

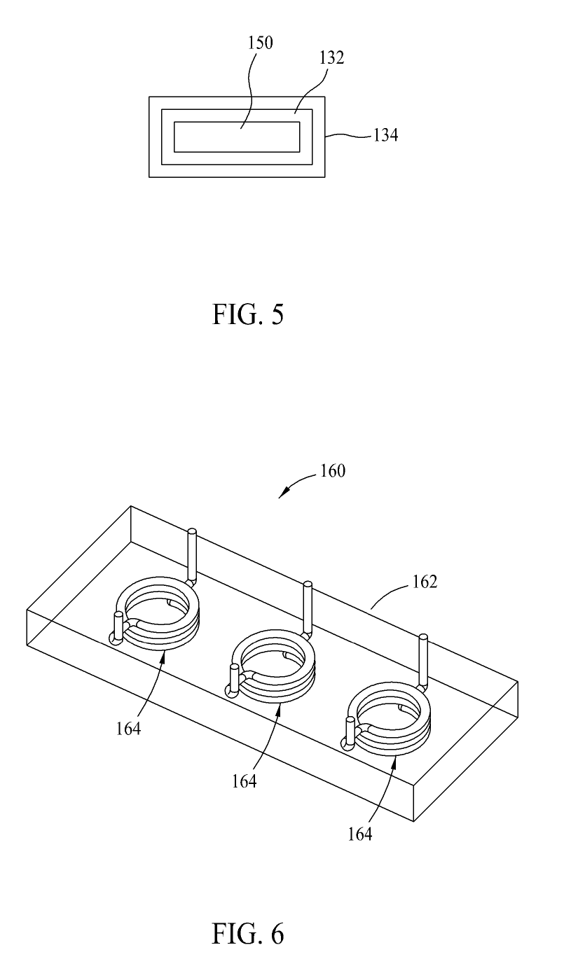

As shown in FIG. 5, the wire conductor 150 is seen in the center of the cross section. In the example shown in FIG. 5, the wire conductor 150 is generally elongated and rectangular in cross section having opposed and generally flat and planar sides. Hence, the wire conductor 150 is sometimes referred to as a flat wire. The high temperature insulation 132 and/or the bonding agent 134 may optionally be provided as explained above, with similar advantages.

Still other shapes of wire conductors are possible to fabricate the coils 120 or 140. That is, the wires need not be round or flat, but may have other shapes if desired.

FIG. 6 illustrates another magnetic component assembly 160 that generally includes a moldable magnetic material defining a magnetic body 162 and plurality of multi-turn wire coils 164 coupled to the magnetic body. Like the foregoing embodiments, the magnetic body 162 may be pressed around the coils 164 in a relatively simple manufacturing process. The coils 164 are spaced from one another in the magnetic body and are independently operable in the magnetic body 162. As shown in FIG. 6, three wire coils 164 are provided, although a greater or fewer number of coils 164 may be provided in other embodiments. Additionally, while the coils 164 shown in FIG. 6 are fabricated from round wire conductors, other types of coils may alternatively be used, including but not limited to any of those described herein or in the related applications identified above. The coils 164 may optionally be provided with high temperature insulation and/or bonding agent as described above.

The moldable magnetic material defining the magnetic body 162 may be any of the materials mentioned above or other suitable materials known in the art. While magnetic powder materials mixed with binder are believed to be advantageous, neither powder particles nor a non-magnetic binder material are necessarily required for the magnetic material forming the magnetic body 162. Additionally, the moldable magnetic material need not be provided in sheets or layers as described above, but rather may be directly coupled to the coils 164 using compression molding techniques or other techniques known in the art. While the body 162 shown in FIG. 6 is generally elongated and rectangular, other shapes of the magnetic body 162 are possible.

The coils 164 may be arranged in the magnetic body 162 so that there is flux sharing between them. That is, adjacent coils 164 may share common flux paths through portions of the magnetic body.

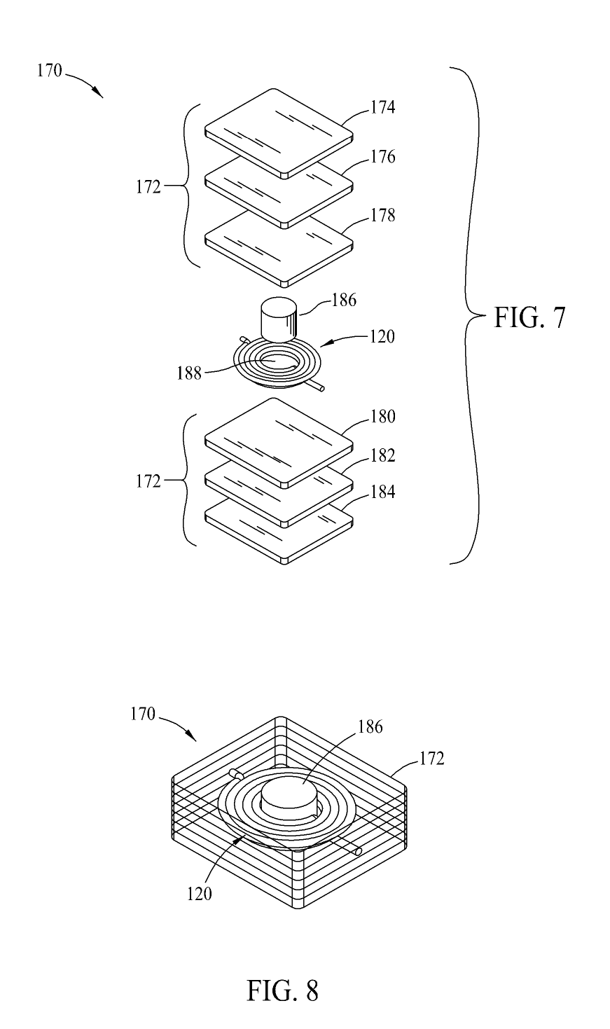

FIGS. 7 and 8 illustrate another miniaturized magnetic component assembly 170 generally including a powdered magnetic material defining a magnetic body 172 and the coil 120 coupled to the magnetic body. The magnetic body 172 is fabricated with moldable magnetic layers 174, 176, 178 on one side of the coil 120, and moldable magnetic layers 180, 182, 184 on the opposing side of the coil 120. While six layers of magnetic material are shown, it is understood that greater or fewer numbers of magnetic layers may be provided in further and/or alternative embodiments. It is also contemplated that a single sheet, such as the upper sheet 178 may define the magnetic body 172 in certain embodiments without utilizing any other sheet.

In an exemplary embodiment, the magnetic layers 174, 176, 178, 180, 182, 184 may include powdered magnetic material such as any of the powdered materials described above or other powdered magnetic material known in the art. While layers of magnetic material are shown in FIG. 7, the powdered magnetic material may optionally be pressed or otherwise coupled to the coil directly in powder form without prefabrication steps to form layers as described above.

All the layers 174, 176, 178, 180, 182, 184 may be fabricated from the same magnetic material in one embodiment such that the layers 174, 176, 178, 180, 182, 184 have similar, if not identically magnetic properties. In another embodiment, one or more of the layers 174, 176, 178, 180, 182, 184 may be fabricated from a different magnetic material than other layers in the magnetic body 172. For example, the layers 176, 180 and 184 may be fabricated from a first moldable material having first magnetic properties, and layers 174, 178 and 182 may be fabricated from a second moldable magnetic material having second properties that are different from the first properties.

Unlike the previous embodiments, the magnetic component assembly 170 includes a shaped core element 186 inserted through the coil 120. In an exemplary embodiment, the shaped core element 186 may be fabricated from a different magnetic material than the magnetic body 172. The shaped core element 186 may be fabricated from any material known in the art, including but not limited to those described above. As shown in FIGS. 7 and 8, the shaped core element 186 may be formed into a generally cylindrical shape complementary to the shape of the central opening 188 of the coil 120, although it is contemplated that non-cylindrical shapes may likewise be used with coils having non-cylindrical openings. In still other embodiments, the shaped core element 186 and the coil openings need not have complementary shapes.

The shaped core element 186 may be extended through the opening 186 in the coil 120, and the moldable magnetic material is then molded around the coil 120 and shaped core element 186 to complete the magnetic body 172. The different magnetic properties of the shaped core element 186 and the magnetic body 172 may be especially advantageous when the material chosen for the shaped core element 186 has better properties than the moldable magnetic material used to define the magnetic body 172. Thus, flux paths passing though the core element 186 may provide better performance than if the magnetic body otherwise would. The manufacturing advantages of the moldable magnetic material may result in a lower component cost than if the entire magnetic body was fabricated from the material of the shaped core element 186.

While one coil 120 and core element 186 is shown in FIGS. 7 and 8, it is contemplated that more than one coil and coil element may likewise be provided in the magnetic body 172. Additionally, other types of coils, including but not limited to those described above or in the related applications identified above, may be utilized in lieu of the coil 120 as desired.

Surface mount termination structure may also be provided on the magnetic component assembly 170 to provide a chip-type component familiar to those in the art. Such surface mount termination structure may include any terminal structure identified in the related disclosures herein incorporated by reference or other terminal structure known in the art. The component assembly 170 may accordingly be mounted to a circuit board using the surface mount termination structure and known techniques. The miniaturized, low profile component assembly 170 therefore facilitates a relatively high power, high performance magnetic component that occupies a relatively smaller space (both in terms of the footprint and profile) in a larger circuit board assembly and enables even further reduction in the size of circuit board assemblies. More powerful, yet smaller electronic devices including the circuit board assemblies are therefore made possible.

### III. Exemplary Embodiments Disclosed

The benefits of the invention are now believed to be evident from the foregoing examples and embodiments.

An exemplary embodiment of a magnetic component assembly includes: a laminated structure comprising: at least one pre-fabricated layer of magnetic sheet material; and at least one pre-fabricated coil; the at least one pre-fabricated layer being compressed around the pre-fabricated coil, thereby forming a single piece magnetic body containing the coil. No physical gap is formed in the magnetic body, and the assembly may define a power inductor.

Optionally, the at least one pre-fabricated layer of magnetic sheet material includes a mixture of magnetic powder particles and a polymeric binder. The magnetic particles may be selected from the group of Ferrite particles, Iron (Fe) particles, Sendust (Fe—Si—Al) particles, MPP (Ni—Mo—Fe) particles, HighFlux (Ni—Fe) particles, Megaflux (Fe—Si Alloy) particles, iron-based amorphous powder particles, cobalt-based amorphous powder particles, and equivalents and combinations thereof. The at least one pre-fabricated layer of magnetic sheet material may include at least two layers of magnetic sheet materials, with the at least one pre-fabricated coil sandwiched between the at least two layers of magnetic sheet materials. At least two layers of magnetic sheet materials may each be fabricated from different types of magnetic powder particles, whereby the at least two of the plurality of layers of magnetic sheet materials exhibit different magnetic properties from one another.

The at least one pre-fabricated layer of magnetic sheet material may have a relative magnetic permeability greater than about 10. The polymeric binder may be a thermoplastic resin.

The coil may define a central opening, and the component assembly may further comprising a shaped magnetic core element. The shaped magnetic core element may be separately provided from the shaped core element and fitted within the central opening. The at least one pre-fabricated layer of magnetic sheet material may include at least two layers of magnetic sheet materials, with the at least one pre-fabricated coil sandwiched between the at least two layers of magnetic sheet materials, and with the shaped magnetic core element also being sandwiched between the at least two layers of magnetic sheet materials. The shaped magnetic core element may be substantially cylindrical.

The coil may include a wire conductor that is flexibly wound around an axis for a number of turns to define a winding portion. The wire conductor may be round or flat. The number of turns may include at least one of straight conductive paths joined at their ends, curved conductive paths, spiral conductive paths, and serpentine conductive paths. The coil may be formed as a three dimensional, free standing coil element. The coil may be provided with a bonding agent. The coil may be connected to a lead frame.

A method of manufacturing a magnetic component is also disclosed. The component includes a coil winding and a magnetic body therefore, and the method includes: compression molding at least one pre-fabricated layer of magnetic sheet material about at least one pre-fabricated coil winding, thereby forming a laminated magnetic body containing the coil winding.

Compression molding may not involve heat lamination. The coil winding may include a central opening, and the method may further include applying a separately fabricated shaped core element to the central opening.

A product may be obtained by the method. The at least one pre-fabricated layer of magnetic sheet material may have a relative magnetic permeability of at least about 10. The at least one pre-fabricated layer of magnetic sheet material may include a mixture of magnetic powder particles and a polymeric binder. The polymer binder may be a thermoplastic resin. The at least one pre-fabricated layer of magnetic sheet material may include at least two layers of magnetic sheet material, the two layers of magnetic sheet material including different types of magnetic particles and therefore having different magnetic properties. The product may be a miniature power inductor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A magnetic component assembly comprising:
a laminated structure comprising:
at least one pre-fabricated layer of magnetic sheet material; and
at least one pre-fabricated coil;
the at least one pre-fabricated layer being compressed around the pre-fabricated coil, thereby forming a single piece magnetic body containing the coil.

2. The magnetic component assembly of claim 1, wherein the at least one pre-fabricated layer of magnetic sheet material includes a mixture of magnetic powder particles and a polymeric binder.

3. The magnetic component assembly of claim 2, wherein the magnetic particles are selected from the group of Ferrite particles, Iron (Fe) particles, Sendust (Fe—Si—Al) particles, MPP (Ni—Mo—Fe) particles, HighFlux (Ni—Fe) particles, Megaflux (Fe—Si Alloy) particles, iron-based amorphous powder particles, cobalt-based amorphous powder particles, and equivalents and combinations thereof.

4. The magnetic component assembly of claim 2, wherein the at least one pre-fabricated layer of magnetic sheet material includes at least two layers of magnetic sheet materials, the at least one pre-fabricated coil sandwiched between the at least two layers of magnetic sheet materials.

5. The magnetic component assembly of claim 1, wherein the at least one pre-fabricated layer of magnetic sheet material includes at least two layers of magnetic sheet materials each fabricated from different types of magnetic powder particles, whereby the at least two of the plurality of layers of magnetic sheet materials exhibit different magnetic properties from one another.

6. The magnetic component assembly of claim 1, wherein the at least one pre-fabricated layer of magnetic sheet material has a relative magnetic permeability greater than about 10.

7. The magnetic component assembly of claim 2, wherein the polymeric binder comprises a thermoplastic resin.

8. The magnetic component assembly of claim 1, wherein the coil defines a central opening, the component assembly further comprising a shaped magnetic core element.

9. The magnetic component assembly of claim 8, wherein the shaped magnetic core element is separately provided from the shaped core element and fitted within the central opening.

10. The magnetic component assembly of claim 9, wherein the at least one pre-fabricated layer of magnetic sheet material includes at least two layers of magnetic sheet materials, the at least one pre-fabricated coil sandwiched between the at least two layers of magnetic sheet materials, and wherein the shaped magnetic core element is also sandwiched between the at least two layers of magnetic sheet materials.

11. The magnetic component of claim 8, wherein the shaped magnetic core element is substantially cylindrical.

12. The magnetic component of claim 1, wherein the coil comprises a wire conductor that is flexibly wound around an axis for a number of turns to define a winding portion.

13. The magnetic component of claim 12, wherein the wire conductor is round.

14. The magnetic component of claim 12, wherein the wire conductor is flat.

15. The magnetic component of claim 12, wherein the number of turns includes at least one of straight conductive paths joined at their ends, curved conductive paths, spiral conductive paths, and serpentine conductive paths.

16. The magnetic component of claim 12, wherein the coil is formed as a three dimensional, free standing coil element.

17. The magnetic component of claim 12, wherein the coil is provided with a bonding agent.

18. The magnetic component of claim 12, wherein the coil is connected to a lead frame.

19. The magnetic component of claim 1, wherein no physical gap is formed in the magnetic body.

20. The magnetic component assembly of claim 1, wherein the assembly defines a power inductor.

21. A method of manufacturing a magnetic component, the component including a coil winding and a magnetic body therefor; the method comprising:
compression molding at least one pre-fabricated layer of magnetic sheet material about at least one pre-fabricated coil winding, thereby forming a laminated magnetic body containing the coil winding.

22. The method of claim 21, wherein the compression molding does not involve heat lamination.

23. The method of claim 21, the coil winding including a central opening, the method further comprising:
applying a separately fabricated shaped core element to the central opening.

24. A product obtained by the method of claim 21.

25. The product of claim 23, wherein the at least one pre-fabricated layer of magnetic sheet material has a relative magnetic permeability of at least about 10.

26. The product of claim 25, wherein the at least one pre-fabricated layer of magnetic sheet material includes a mixture of magnetic powder particles and a polymeric binder.

27. The product of claim 26, wherein the polymer binder is a thermoplastic resin.

28. The product of claim 27, wherein the at least one pre-fabricated layer of magnetic sheet material comprises at least two layers of magnetic sheet material, the two layers of magnetic sheet material including different types of magnetic particles and therefore having different magnetic properties.

29. The product of claim 24, wherein the product is a miniature power inductor.
